(19) United States
(12) Patent Application Publication
(10) Pub. No.: US 2015/0213511 A1
(43) Pub. Date: Jul. 30, 2015

(54) BID ADJUSTMENT BASED ON PRESENTATION OF RELATED CONTENT THROUGH OTHER COMMUNICATION MEDIUM

(71) Applicant: Google Inc., Mountain View, CA (US)

(72) Inventors: William Patrick Kee, San Francisco, CA (US); David Barney, Mission Viejo, CA (US)

(73) Assignee: Google Inc., Mountain View, CA (US)

(21) Appl. No.: 14/167,383

(22) Filed: Jan. 29, 2014

(51) Int. Cl. G06Q 30/02

(52) U.S. Cl. CPC G06Q 30/0275; G06Q 30/0256

(57) ABSTRACT

Systems, methods, and computer-readable storage media that may be used to adjust bid settings based on content presented through other communication media are provided. One method includes determining a time at which a first content item of a content provider is likely to have been presented to a plurality of users through a first communication medium. The method further includes adjusting a current bid setting for at least one bid for one or more auctions to be displayed through a content interface on one or more user devices. The bid is adjusted for a time period after the determined time, and is associated with at least one second content item that is related to a subject matter of the first content item. The method further includes applying the adjusted bid setting to the at least one bid for content auctions that are conducted during the time period.

### BACKGROUND

Content providers often invest substantial resources into online marketing efforts. For example, content providers may submit bids to online content management systems to have one or more content items from a content campaign displayed to users. The same content providers often also invest in other marketing channels, such as television and/or radio marketing. Content marketed through these other channels can have an impact on user behavior with respect to the subject matter of the content (e.g., the content provider's brands), but the online marketing efforts of the content provider may not be designed to leverage the impact from these other marketing channels.

### SUMMARY

One illustrative implementation of the disclosure relates to a method that includes determining, using a computerized content management system, a time at which a first content item of a content provider is likely to have been presented to a plurality of users through a first communication medium. The content management system is configured to receive one or more bids from the content provider for one or more content auctions for content items to be displayed within a content interface presented on one or more user devices. The content interface is a different medium than the first communication medium. The method further includes adjusting, using the content management system, a current bid setting for at least one bid of the one or more bids for a time period after the determined time to generate an adjusted bid setting. The at least one bid is associated with at least one second content item that is related to a subject matter of the first content item. The method further includes applying, using the content management system, the adjusted bid setting to the at least one bid for content auctions of the one or more content auctions that are conducted during the time period. The adjusted bid setting is configured to increase a likelihood that the at least one second content item will be selected for display within the content interface during the time period.

Another implementation relates to a system that includes at least one computing device operably coupled to at least one memory and configured to determine a time at which a first content item of a content provider is likely to have been presented to a plurality of users through a first communication medium. The at least one computing device is configured to receive one or more bids from the content provider for one or more content auctions for content items to be displayed within a content interface presented on one or more user devices, and the content interface is a different medium than the first communication medium. The at least one computing device is further configured to adjust a current bid setting for at least one bid of the one or more bids for a time period after the determined time to generate an adjusted bid setting. The at least one bid is associated with at least one second content item that is related to a subject matter of the first content item. The at least one computing device is further configured to apply the adjusted bid setting to the at least one bid for content auctions of the one or more content auctions that are conducted during the time period. The adjusted bid setting is configured to increase a likelihood that the at least one second content item will be selected for display within the content interface during the time period.

Yet another implementation relates to one or more computer-readable storage media having instructions stored thereon that, when executed by at least one processor, cause the at least one processor to perform operations. The operations include determining a time at which a first content item of a content provider is likely to have been presented to a plurality of users through a broadcast communication medium based on at least one of a schedule received from the content provider or analysis of traffic data indicative of user activity relating to a subject matter of the first content item. The at least one processor is configured to receive one or more bids from the content provider for one or more content auctions for content items to be displayed within a content interface presented on one or more user devices, and the content interface is a different medium than the broadcast communication medium. The operations further include adjusting a current bid setting for at least one bid of the one or more bids for a time period after the determined time to generate an adjusted bid setting. The at least one bid is associated with at least one second content item that is related to the subject matter of the first content item. The operations further include applying the adjusted bid setting to the at least one bid for content auctions of the one or more content auctions that are conducted during the time period. The adjusted bid setting is configured to increase a likelihood that the at least one second content item will be selected for display within the content interface during the time period. The operations further include returning the adjusted bid setting to the current bid setting after the time period has expired.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a content management system and associated environment according to an illustrative implementation.

FIG. 2 is a flow diagram of a process for adjusting bid settings for a time period after a time at which a related content item is likely to have been presented through a first (e.g., broadcast) communication medium according to an illustrative implementation.

FIG. 3 is a flow diagram of a process for determining a time at which a content item is expected to be presented through the first (e.g., broadcast) communication medium based on a schedule received from the content provider according to an illustrative implementation.

FIG. 4A is a flow diagram of a process for determining a time at which a content item is expected to be presented through the first (e.g., broadcast) communication medium based on analysis of traffic data indicative of user activity relating to the subject matter of the content item according to an illustrative implementation.

FIG. 4B is a graph illustrating traffic data relating to subject matter of a particular content item according to an illustrative implementation.

FIG. 5 is a flow diagram of a process for determining a duration of the time period over which an adjusted bid setting is applied based on analysis of historical traffic data according to an illustrative implementation.

FIG. 6 is a flow diagram of a process for determining a duration of the time period over which an adjusted bid setting is applied based on analysis of real-time traffic data according to an illustrative implementation.

FIG. 7 is a flow diagram of a process for determining an adjustment amount to be applied to the current bid setting to generate the adjusted bid setting based on traffic data according to an illustrative implementation.

FIG. 8 is a flow diagram of a process for detecting when a content item has been presented through the first (e.g., broadcast) communication medium by comparing stored content samples to a content stream transmitted through the first communication medium according to an illustrative implementation.

FIG. 9 is a block diagram of a computing system according to an illustrative implementation.

### DETAILED DESCRIPTION

Referring generally to the Figures, various illustrative systems and methods are provided that may be used to adjust bid settings for a content campaign in response to determining that a related content item in another marketing channel, such as television or radio, has recently been presented. Content providers spend significant amounts of money running content items in various media channels, such as television and radio. These channels generate significant branded and non-branded online search response in the minutes following the presentation (e.g., broadcast) of the content item. Search queries for related search terms can increase as much as 30-50 percent or more in the minutes (e.g., two to three minutes) following airing of a television content item. Content providers often do not capture the impressions share of content items displayed online (e.g., search content items and/or display content items) in those critical several minutes following the television item airing. Accordingly, content providers have paid to generate demand that they are not harvesting through the online marketing channels. Increasing bids at all times in an effort to capture this demand is generally overly expensive and inefficient.

The present disclosure provides systems and methods that leverage the increased demand by adjusting bid settings in an effort to increase exposure of the content campaign in the timeframe following presentation of content through the other marketing channels. An illustrative content management system may be configured to determine a time at which a first content item (e.g., a television or radio marketing item) of a content provider is likely to have been presented to a plurality of users through a first communication medium, such as a television or radio station. The system may be configured to adjust one or more bid settings (e.g., increase a bid value and/or apply a multiplier) for content items having subject matter relating to the first content item for a time period after the determined time (e.g., a short time period after presentation of the first content item, such as two minutes). For a duration of the time period, the system may apply the adjusted bid settings when conducting auctions involving the content items. The adjusted bid settings may be configured to increase a likelihood that the content items will be selected for presentation to the plurality of users within a content item interface displayed on user devices of the users. The content item interface is different than the first communication medium. Once the duration has elapsed, the bid settings may be returned to the original settings prior to adjustment.

In some implementations, the time at which the first content item is likely to be presented may be determined based on a schedule of content items to be presented through the first communication medium (e.g., a schedule of upcoming television marketing items). In some implementations, the time may be determined by analyzing traffic data relating to the subject matter of the first content item. For example, if a volume of search keywords relating to the subject matter of the first content item and/or a volume of traffic to resources (e.g., webpages) having content related to the subject matter of the first content item increases substantially (e.g., above a threshold level and/or rate), the system may infer that the increase is due to presentation of the first content item through the first communication medium. In some implementations, the bid adjustment may be determined at least in part on a magnitude of the traffic data. For example, if the traffic data indicates a 25 percent rise in traffic, a first bid multiplier may be applied, and if the traffic data indicates a 55 percent rise in traffic, a higher second bid multiplier may be applied.

The duration of the bid adjustment may be determined statically or dynamically. For example, the duration may be a static amount of time after the time at which the first content item is likely presented, such as two or three minutes. In some implementations, the duration may be determined dynamically, such as based on traffic data. The dynamic adjustment may be performed based on historical data pertaining to one or more previous instances associated with content items likely having been provided through the first communication medium and/or real-time data collected while the bid adjustment is being applied.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

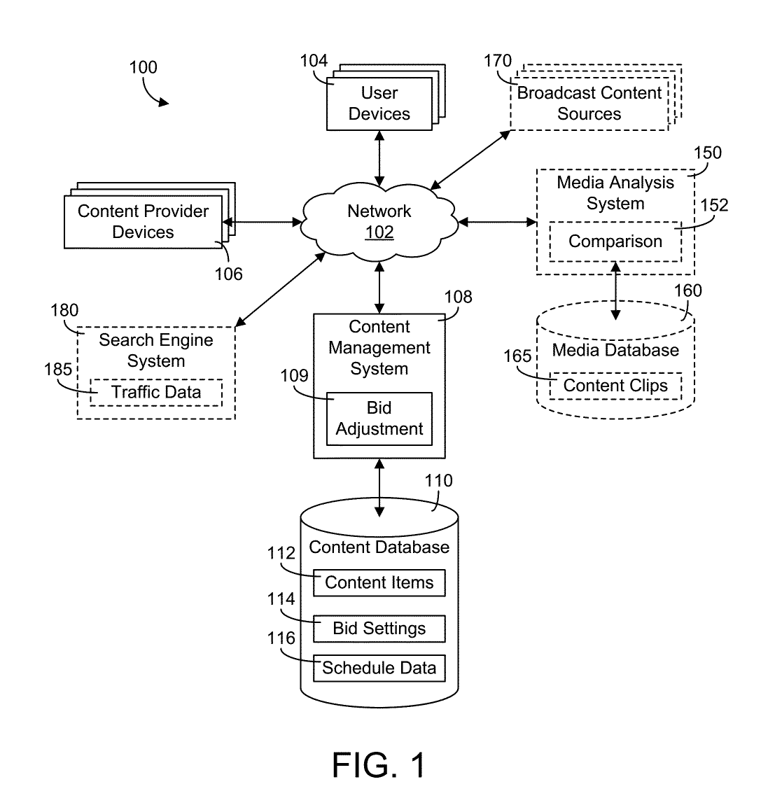

Referring now to FIG. 1, and in brief overview, a block diagram of a content management system 108 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

Content management system 108 may be configured to provide for adjustment of one or more bid settings (e.g., a bid value, such as a maximum cost per click (CPC) bid) upon the occurrence of certain conditions. For example, in some implementations, system 108 may allow a content provider to specify a bid adjustment, such as a bid addition or bid multiplier, to be applied to one or more bid values of the content provider in the event a quality score (e.g., a score indicating a relevance to the user of the subject matter for the content item associated with the bid) exceeds a predetermined threshold level. A bid addition may add a certain value amount to the bid value. A bid multiplier may multiply the bid value by a certain amount.

Content management system 108 may be configured to provide bid adjustments based on related content being presented to users through another communication medium, such as a broadcast communication medium (e.g., television channel or radio station). System 108 may determine a time at which a broadcast content item is likely to be presented through the broadcast medium, for example, based on a schedule provided by the content provider and/or analysis of traffic data indicative of user activity relating to subject matter of the broadcast content item. In some implementations, the traffic data may include a volume of search queries (e.g., search engine queries, media search queries, etc.) relating to the subject matter of the broadcast content item. In some implementations, the traffic data may additionally or alternatively include a volume of user traffic (e.g., webpage visits) to one or more webpages having subject matter that relates to the subject matter of the broadcast content item. System 108 may apply a bid adjustment to one or more current bid settings for one or more bids of the content provider for a time period after the time at which the broadcast item was likely presented. The bids for which the adjustment is applied may be associated with content items having subject matter related to the subject matter of the broadcast item (e.g., same or similar product/service, brand, product/service category, etc.). System 108 may apply the adjusted bid setting(s) for any auctions conducted during the time period to increase the likelihood that content items of the content provider will be displayed to users during the time period. For example, if a content item relating to a fictional Acme Truck is broadcast to users via a television channel, the content provider Acme may configure its account via system 108 to temporarily increase bids for content items relating to the Acme Truck for a limited time after the television item is displayed. This may increase the likelihood that users may be presented with content items related to the television item during the time period immediately after the television item has likely aired, including users who may have seen the television item and initiated an online activity relating to the subject matter of the television item (e.g., submitted a search query relating to the television item to an online search engine, visited a webpage relating to the television item, etc.). Such users may be more receptive to clicking through the content items presented by system 108 and/or performing a conversion (e.g., purchasing a product/service associated with the content item, providing desired information to the content provider, etc.).

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another implementation, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other parameters that may control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of a particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Content management system 108 may include a bid adjustment module 109 configured to provide for adjustment of one or more bid settings 114 based on content presented through another communication medium, such as a broadcast medium. System 108 may determine when a content item has likely been presented through the broadcast medium. In some implementations, system 108 may determine when the content item has likely been presented based on schedule data 116 provided by the content provider that identifies one or more times at which content is scheduled to be provided through the broadcast medium. In some implementations, system 108 may additionally or alternatively determine the time based on traffic data 185 indicative of user activity relating to a subject matter of the broadcast content item. In some implementations, traffic data 185 may be received from a search engine system 180 configured to operate an online search engine, and traffic data 185 may be indicative of user search query activity relating to the subject matter of the broadcast item. In other implementations, traffic data 185 may be indicative of webpage traffic for webpages having subject matter similar to that of the broadcast item and/or data indicative of other types of user activity pertaining to the subject matter of the broadcast item. System 108 may be configured to adjust at least one of bid settings 114 for a period of time after the broadcast item is likely to have been provided via the broadcast medium. The adjusted bid settings may be applied for any auctions conducted during the time period. In various implementations, bid settings 114, schedule data 116, and/or traffic data 185 may be stored in content database 110 or in a different computer-readable storage medium.

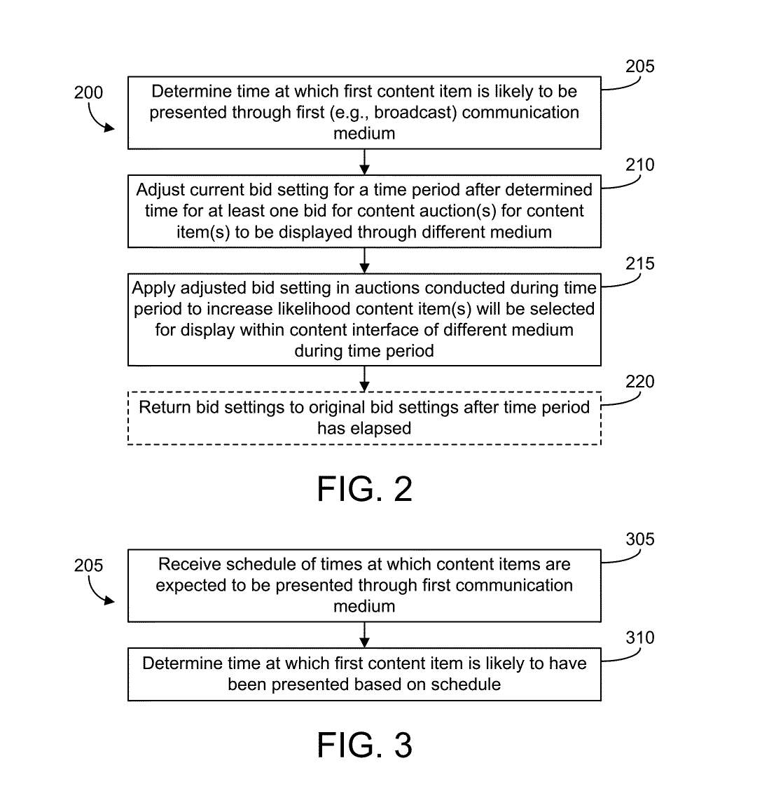

FIGS. 2 through 4A and 5 through 8 illustrate various illustrative processes that may be used to provide bid adjustments based on content provided through another medium in some implementations. For purposes of clarity, the discussion below generally references the other communication medium as being a broadcast medium, such as a television channel or radio station. However, it should be understood that the present disclosure applies equally to other types of media as well, including non-broadcast media. For example, in various illustrative implementations, bid adjustments may be made based on content transmissions made via television (e.g., over-the-air, cable, satellite, etc.), radio (e.g., AM, FM, satellite, etc.), the Internet (e.g., Internet-based television, radio, and/or other types of Internet or other local or wide-area-network-based audio and/or video sources), and/or any other type of communication medium configured to transmit content simultaneously to a plurality of users.

FIG. 2 illustrates a flow diagram of a process 200 for adjusting bid settings for a time period after a time at which a related content item is likely to have been presented through a first (e.g., broadcast) communication medium according to an illustrative implementation. Referring to both FIGS. 1 and 2, content items may be presented to users through a broadcast medium. The broadcast items may be transmitted by one or more broadcast content sources 170, such as televisions and/or radio stations. Content management system 108 may be configured to determine a time at which a broadcast content item is likely to have been presented to users through the broadcast medium (205).

System 108 may be configured to determine the time at which the broadcast item is likely to have been presented through the broadcast medium in one or more of several ways. For example, FIG. 3 illustrates a flow diagram of a process for determining a time at which items are expected to be broadcast using schedule data 116 provided by the content provider according to an illustrative implementation. System 108 may receive schedule data 116 from the content provider or an agent of the content provider (305). System 108 may provide an interface through which the content provider may provide schedule data 116 to system 108 using a content provider device 106. For example, system 108 may provide a web-based interface through which the content provider may authenticate and provide an electronic schedule. Schedule data 116 may identify one or more broadcast items that are scheduled to be transmitted at one or more future times, the times at which they are scheduled to be transmitted, and the broadcast media (e.g., television channel/station, radio station, etc.) on which they are scheduled to be transmitted. Schedule data 116 may be associated with a predetermined length and/or period of time. In some implementations, a portion of schedule data 116 may specify parameters associated with the schedule, such as a timeframe associated with the schedule, one or more broadcast content sources 170 with which content items appearing in the schedule are associated, and/or other information. Schedule data 116 may be provided in any format, such as a spreadsheet, a comma separated values (CSV) file, a document file, or any other format suitable for interpretation by system 108.

System 108 may determine a time at which one or more broadcast items are scheduled to be presented based on schedule data 116 (310). In some implementations, schedule data 116 may be in a predetermined format, and bid adjustment module 109 may be configured to parse schedule data 116 to identify the broadcast items within the schedule and the times and/or broadcast media associated with the broadcast items. Data regarding the broadcast items/times/media may be extracted and saved for use in scheduling bid setting adjustments.

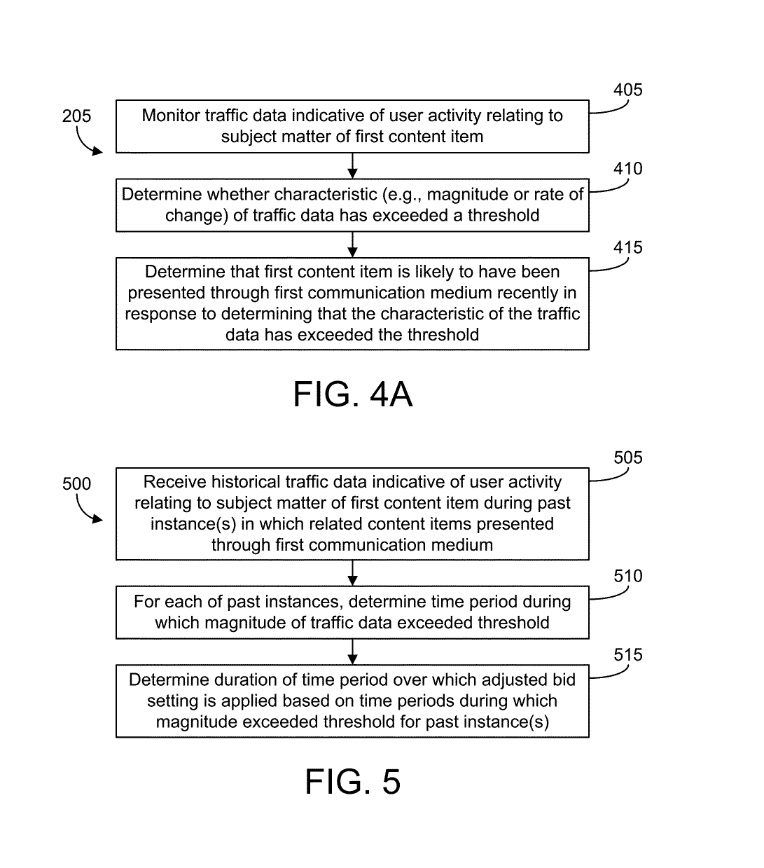

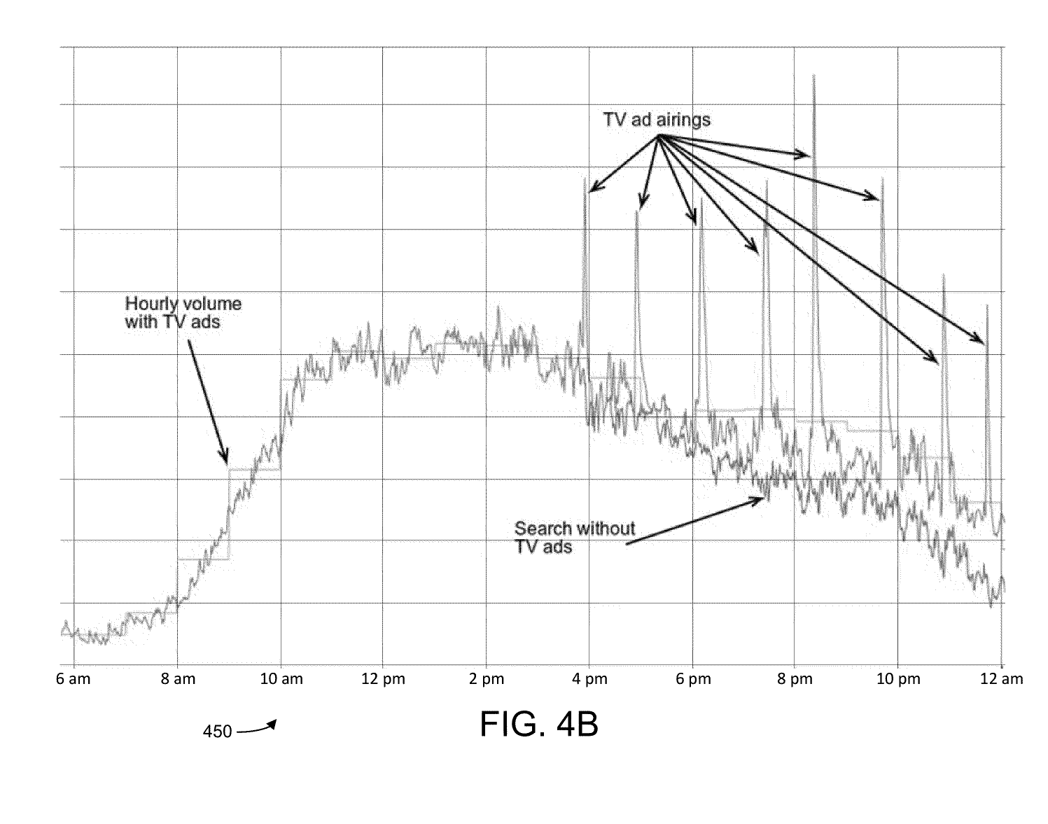

FIG. 4A illustrates a flow diagram of a process for determining times at which items are broadcast by analyzing traffic data 185 indicative of user activity relating to the subject matter of the broadcast item according to an illustrative implementation. System 108 may receive and monitor traffic data 185 (405). In some implementations, traffic data 185 may be received from search engine system 180 and may be indicative of user search query submissions (e.g., volume of search queries) relating to the subject matter of the broadcast item. For example, if the broadcast content item is an item designed to market a fictional shoe brand Acme Shoes, then traffic data relating to user queries including “Acme Shoes” and similar search terms may be monitored. In some implementations, traffic data 185 may be other user behavior data relating to the broadcast item subject matter, such as information regarding user traffic to one or more websites/webpages having subject matter related to the broadcast item subject matter.

System 108 may determine whether a characteristic of traffic data 185 has exceeded a threshold (410). For example, system 108 may determine whether a magnitude (e.g., a volume of queries relating to the subject matter of the broadcast item) of traffic data 185 has exceeded a threshold magnitude value. In another example, system 108 may additionally or alternatively determine whether a rate of change (e.g., a change in the volume of search queries relating to the broadcast item subject matter over a unit of time, such as five seconds, 15 seconds, one minute, etc.) of traffic data 185 has exceeded a threshold rate of change value. System 108 may determine that the broadcast content item was likely recently presented through the broadcast medium in response to determining that the characteristic of traffic data 185 has exceeded the threshold (415). Steep and/or quick increases in online user traffic relating to a particular type of subject matter can be a reliable indicator that a content item relating to the subject matter has been presented through a different medium.

FIG. 4B illustrates a graph 450 showing traffic data for one or more types of user search queries relating to the subject matter of a particular content item broadcast via a television channel according to an illustrative implementation. The horizontal axis of graph 450 illustrates a timeframe, and the vertical axis represents a volume of search queries submitted to search engine system 180 during the timeframe. As can be seen in graph 450, a series of sharp peaks in the query volume relating to the subject matter appear starting around 4 pm. Each of the peaks is likely driven by the television item recently being aired. Graph 450 also illustrates an estimated query volume if the television items were not aired, as well as an average hourly volume for each hour shown in graph 450 with the aired television items.

Referring again to FIGS. 1 and 2, system 108 may adjust one or more current bid settings (e.g., a current bid value, such as a cost per click (CPC) or cost per thousand impressions (CPM) bid) of bid settings 114 for a time period after the determined time at which the broadcast item is likely to have been presented to users (210). The current bid settings may be adjusted for at least one bid for one or more content auctions to be displayed to users via a user interface on user devices 104. The bid(s) for which the current bid settings are adjusted may have a subject matter related to the subject matter of the broadcast content item. For example, a fictional content provider Acme may configure its account with system 108 such that a bid multiplier is applied to a current bid value for bids featuring its Acme Shoes brand for a time period immediately after a television item for Acme Shoes is aired. The adjustment applied to the current bid settings to generate the adjusted bid settings may be a bid addition, a bid multiplier, and/or any other type of modifier that would modify the bid settings. System 108 may apply the adjusted bid settings in auctions conducted during the time period involving the relevant bids (215). The adjustments may increase the likelihood that the content items associated with the bids will be selected by system 108 for display within the content interfaces presented to users on user devices 104. In some implementations, system 108 may return bid settings 114 to their original, pre-adjustment values after the duration of the time period has expired (220).

In some implementations, system 108 may allow a content provider to specify a desired goal to be met during the time period. For example, a content provider may indicate that, during the time period, the content provider wishes to bid an amount sufficient for its content items to appear in no lower than the second position of the content interface presented to users during the time period, and system 108 may apply bid adjustments while conducting the auctions to meet the stated goal of the content provider. In some implementations, the content provider may specify that a maximum portion of a budget to be used during the time period after the broadcast item is presented. For example, the content provider may indicate that up to 70 percent of a daily budget may be used during the time periods after airing of broadcast items, while the remaining 30 percent is to be reserved for other time periods. System 108 may monitor the budget while conducting auctions (e.g., in real-time or near real-time) to ensure that the budget constraints are observed when applying bid adjustments.

System 108 may determine a duration of the time period and/or adjustment amount using one or more of a variety of methods. For example, the duration and/or adjustment amount may be a static value (e.g., a two minute duration after the time at which the broadcast item is likely to have been presented, a bid multiplier of 1.3×, etc.). The duration and/or adjustment amount may be based on characteristics of the broadcast item and/or bids, such as a category of subject matter, current bid value, amount of budget dedicated to the content item and/or content group associated with the bids (e.g., if the content item appears to be of significant importance to the content provider, the duration and/or adjustment may be increased), and/or other factors.

In some implementations, the duration and/or adjustment amount may be determined based on traffic data 185. FIG. 5 illustrates a flow diagram of a process 500 for determining a duration of the time period over which an adjusted bid setting is applied based on analysis of historical traffic data according to an illustrative implementation. System 108 may receive historical traffic data indicative of user activity relating to the subject matter of the broadcast item during one or more past instances in which the broadcast item and/or related items were presented through the broadcast medium (505). For each of the past instances, system 108 may determine a time period during which the magnitude of the traffic data exceeded a threshold magnitude value (510). System 108 may determine the duration of the time period over which the adjusted bid settings are applied based on a combination of the time periods during which the magnitude exceeded the threshold for the past instances (515). In some implementations, system 108 may determine the duration by averaging the durations associated with the past instances. For example, if the magnitude of the traffic data exceeded a threshold magnitude for 1.5 minutes, 2 minutes, 3 minutes, and 2.5 minutes after which a television item was broadcast in past instances, system 108 may determine that the bid adjustment should be applied for a duration of 2.25 minutes (i.e., two minutes and 15 seconds) after the time at which the television item is likely to have been broadcast. In other implementations, other methods of combining the data for the past instances, such as taking the median or mode, or determining the final value based on a standard deviation of the historical values, may be used.

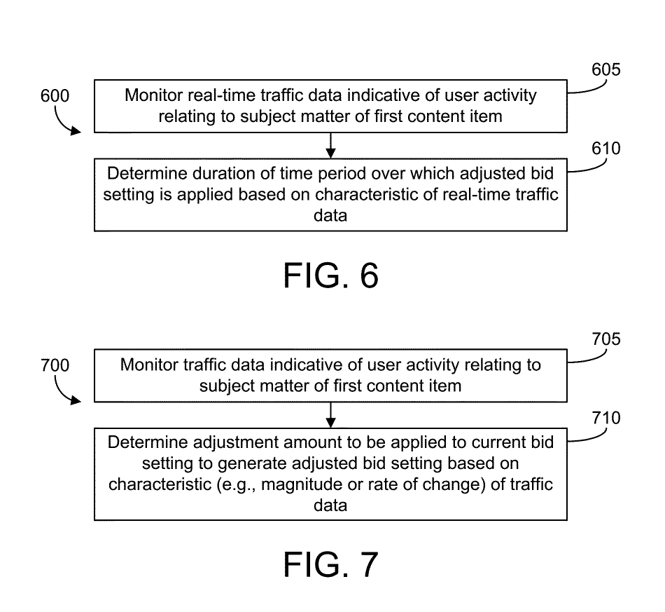

FIG. 6 illustrates a flow diagram of a process 600 for determining the duration based on analysis of real-time traffic data according to an illustrative implementation. System 108 may monitor real-time or near real-time traffic data indicative of current user activity relating to the subject matter of the broadcast item (605). System 108 may determine the duration based on a characteristic (e.g., magnitude, rate of change, etc.) of the real-time traffic data (610). For example, if the real-time traffic data indicates a rate increase of 300 queries/second, a first bid multiplier may be applied, and if the real-time traffic data indicates a rate increase of 600 queries/second, a second bid multiplier higher than the first multiplier may be applied. In some implementations, the real-time traffic data may be used in combination with historical traffic data to determine the duration of the time period over which the adjustment is applied. For example, if system 108 calculates a duration of three minutes based on historical traffic data, but the rate of change and/or magnitude of the real-time traffic data is larger than the corresponding characteristics of the historical data, system 108 may increase the duration over which the bid setting adjustment is applied.

FIG. 7 illustrates a flow diagram of a process 700 for determining an adjustment amount to be applied to the current bid setting to generate the adjusted bid setting based on traffic data 185 (e.g., historical and/or real-time traffic data) according to an illustrative implementation. System 108 may monitor traffic data 185 indicative of user activity relating to the subject matter of the broadcast item (705). System 108 may determine the adjustment amount based on a characteristic (e.g., magnitude or rate of change) of the traffic data (710). For example, if a magnitude of the historical and/or real-time traffic data is at a first level, system 108 may apply a first bid adjustment, and if the magnitude is at a second level higher than the first level, system 108 may apply a higher second bid adjustment. In some implementations, system 108 may allow a content provider to specify minimum and/or maximum bid adjustment values to be applied.

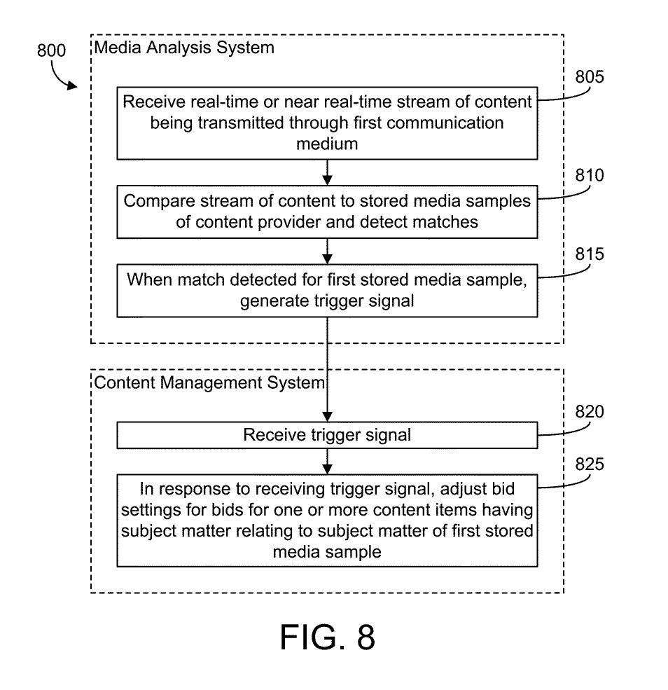

In some implementations, content management system 108 may be configured to trigger adjustment of bid settings 114 in response to stored content samples matching part of a real-time or near real-time stream of content (e.g., a broadcast stream). FIG. 8 illustrates a flow diagram of a process 800 for detecting when a content item has been presented through the first (e.g., broadcast) communication medium by comparing stored content samples to a content stream transmitted through the first communication medium according to an illustrative implementation. Referring to FIGS. 1 and 8, a media analysis system 150 may be configured to receive a real-time or near real-time stream of content being transmitted through a first (e.g., broadcast) communication medium (e.g., from broadcast content sources 170) (805). Media analysis system 150 may be a separate system or may be integrated within content management system 108. In some implementations, media analysis system 150 may be configured to receive and monitor broadcast streams from a set of broadcast media on which a content provider has indicated its content items are scheduled to be presented (e.g., based on schedule data 116, a separate list of broadcast media/providers received from the content provider, etc.). In some implementations, media analysis system 150 may receive streams of several broadcast media, without knowing in advance whether or not content items of the content provider are scheduled to be presented on the media.

A comparison module 152 of media analysis system 150 may be configured to compare stored content clips 165 to the broadcast media streams and detect whether portions of any of the streams match content clips 165 (810). In some implementations, comparison module 152 may be configured to identify a match quickly after the beginning of presentation of the content item via the broadcast medium (e.g., within 15 seconds after the start of the clip). In such implementations, the bid setting adjustment may be able to capture most of the increased user response resulting from the broadcast item, as user response often spikes near the end of the presentation of the broadcast item. When a match is detected for a particular content clip 165, comparison module 152 may generate a trigger signal (815). The trigger signal may be transmitted to content management system 108. In various implementations, the trigger signal may identify the matching content clip 165, the broadcast medium on which the match was detected, a category or content group associated with the matching content clip 165, and/or other information.

Content management system 820 may be configured to receive the trigger signal (820) and, in response to receiving the trigger signal, adjust bid settings for bids for one or more content items having subject matter related to the subject matter of the media sample (825). In some implementations, the trigger signal may serve to identify the approximate time at which the broadcast item was presented via the broadcast medium, and the bid adjustment and application to content auctions may operate in a manner similar to that described with reference to operations 210 and 215 of process 200.

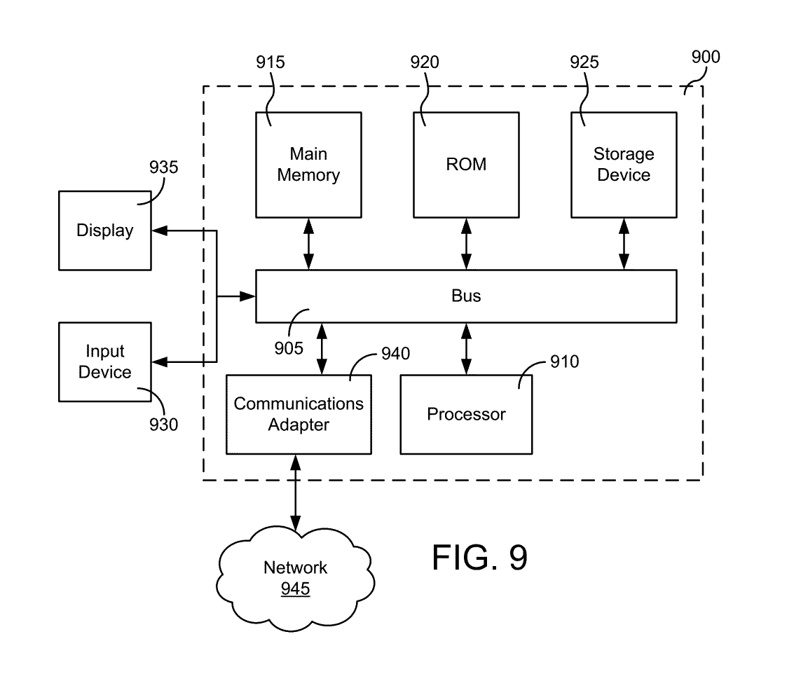

FIG. 9 illustrates a depiction of a computer system 400 that can be used, for example, to implement an illustrative user device 104, an illustrative content management system 108, an illustrative content provider device 106, an illustrative search engine system 180, an illustrative media analysis system 150, and/or various other illustrative systems described in the present disclosure. The computing system 900 includes a bus 905 or other communication component for communicating information and a processor 910 coupled to the bus 905 for processing information. The computing system 900 also includes main memory 915, such as a random access memory (RAM) or other dynamic storage device, coupled to the bus 905 for storing information, and instructions to be executed by the processor 910. Main memory 915 can also be used for storing position information, temporary variables, or other intermediate information during execution of instructions by the processor 910. The computing system 900 may further include a read only memory (ROM) 910 or other static storage device coupled to the bus 905 for storing static information and instructions for the processor 910. A storage device 925, such as a solid state device, magnetic disk or optical disk, is coupled to the bus 905 for persistently storing information and instructions.

The computing system 900 may be coupled via the bus 905 to a display 935, such as a liquid crystal display, or active matrix display, for displaying information to a user. An input device 930, such as a keyboard including alphanumeric and other keys, may be coupled to the bus 905 for communicating information, and command selections to the processor 910. In another implementation, the input device 930 has a touch screen display 935. The input device 930 can include a cursor control, such as a mouse, a trackball, or cursor direction keys, for communicating direction information and command selections to the processor 910 and for controlling cursor movement on the display 935.

In some implementations, the computing system 900 may include a communications adapter 940, such as a networking adapter. Communications adapter 940 may be coupled to bus 905 and may be configured to enable communications with a computing or communications network 945 and/or other computing systems. In various illustrative implementations, any type of networking configuration may be achieved using communications adapter 940, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein. One or more processors in a multi-processing arrangement may also be employed to execute the instructions contained in main memory 915. In alternative implementations, hard-wired circuitry may be used in place of or in combination with software instructions to implement illustrative implementations. Thus, implementations are not limited to any specific combination of hardware circuitry and software.

Although an example processing system has been described in FIG. 9, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including without limitation semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Communication networks may include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
determining, using a computerized content management system, a time at which a first content item of a content provider is likely to have been presented to a plurality of users through a first communication medium, wherein the content management system is configured to receive one or more bids from the content provider for one or more content auctions for content items to be displayed within a content interface presented on one or more user devices, wherein the content interface is a different medium than the first communication medium;
adjusting, using the content management system, a current bid setting for at least one bid of the one or more bids for a time period after the determined time to generate an adjusted bid setting, wherein the at least one bid is associated with at least one second content item that is related to a subject matter of the first content item; and
applying, using the content management system, the adjusted bid setting to the at least one bid for content auctions of the one or more content auctions that are conducted during the time period, wherein the adjusted bid setting is configured to increase a likelihood that the at least one second content item will be selected for display within the content interface during the time period.

2. The method of claim 1, wherein the first communication medium is a broadcast communication medium configured to present the first content item simultaneously to the plurality of users.

3. The method of claim 2, wherein the first communication medium comprises one of a television channel or a radio station.

4. The method of claim 1, further comprising returning the adjusted bid setting to the current bid setting after the time period has expired.

5. The method of claim 1, wherein determining the time at which the first content item is likely to have been presented through the first communication medium comprises:
receiving a schedule from the content provider of times at which content items of the content provider are expected to be presented through the first communication medium; and
determining the time at which the first content item is likely to have been presented through the first communication medium based on the schedule received from the content provider.

6. The method of claim 1, wherein determining the time at which the first content item is likely to have been presented through the first communication medium comprises:
monitoring traffic data indicative of user activity relating to the subject matter of the first content item;
determining whether a characteristic of the traffic data has exceeded a threshold; and
determining that the first content item is likely to have been presented through the first communication medium recently in response to determining that the characteristic of the traffic data has exceeded the threshold.

7. The method of claim 6, wherein the characteristic of the traffic data comprises at least one of a magnitude of the traffic data or a rate of change of the traffic data.

8. The method of claim 1, further comprising determining a duration of the time period over which the adjusted bid setting is applied, wherein determining the duration comprises:
receiving historical traffic data indicative of user activity relating to the subject matter of the first content item during one or more past instances in which content items relating to the subject matter of the first content item were presented through the first communication medium;
for each of the one or more past instances, determining a time period during which a magnitude of the traffic data exceeded a threshold; and
determining the duration of the time period over which the adjusted bid setting is applied based on the time periods during which the magnitude of the traffic data exceeded the threshold for the one or more past instances.

9. The method of claim 1, further comprising determining a duration of the time period over which the adjusted bid setting is applied, wherein determining the duration comprises:
monitoring real-time traffic data indicative of user activity relating to the subject matter of the first content item; and
determining the duration of the time period over which the adjusted bid setting is applied based on a characteristic of the real-time traffic data.

10. The method of claim 1, further comprising:
monitoring traffic data indicative of user activity relating to the subject matter of the first content item; and
determining an adjustment amount applied to the current bid setting to generate the adjusted bid setting based on at least one of a magnitude or a rate of change of the traffic data.

11. The method of claim 1, wherein determining the time at which the first content item is likely to have been presented through the first communication medium comprises:
receiving a content stream being transmitted through the first communication medium;
comparing the content stream to one or more stored content samples associated with the content provider, wherein the one or more stored content samples include the first content item;
determining whether a portion of the content stream matches the first content item; and
in response to determining that the portion of the content stream matches the first content item, activating a trigger signal indicating that the first content item has been presented through the first communication medium;
wherein the current bid setting is adjusted in response to the trigger signal.

12. A system comprising:
at least one computing device operably coupled to at least one memory and configured to:
determine a time at which a first content item of a content provider is likely to have been presented to a plurality of users through a first communication medium, wherein the at least one computing device is configured to receive one or more bids from the content provider for one or more content auctions for content items to be displayed within a content interface presented on one or more user devices, wherein the content interface is a different medium than the first communication medium;
adjust a current bid setting for at least one bid of the one or more bids for a time period after the determined time to generate an adjusted bid setting, wherein the at least one bid is associated with at least one second content item that is related to a subject matter of the first content item; and
apply the adjusted bid setting to the at least one bid for content auctions of the one or more content auctions that are conducted during the time period, wherein the adjusted bid setting is configured to increase a likelihood that the at least one second content item will be selected for display within the content interface during the time period.

13. The system of claim 12, wherein the at least one computing device is configured to determine the time at which the first content item is likely to have been presented through the first communication medium by:
receiving a schedule from the content provider of times at which content items of the content provider are expected to be presented through the first communication medium; and
determining the time at which the first content item is likely to have been presented through the first communication medium based on the schedule received from the content provider.

14. The system of claim 12, wherein the at least one computing device is configured to determine the time at which the first content item is likely to have been presented through the first communication medium by:
monitoring traffic data indicative of user activity relating to the subject matter of the first content item;
determining whether a characteristic of the traffic data has exceeded a threshold; and
determining that the first content item is likely to have been presented through the first communication medium recently in response to determining that the characteristic of the traffic data has exceeded the threshold.

15. The system of claim 14, wherein the characteristic of the traffic data comprises at least one of a magnitude of the traffic data or a rate of change of the traffic data.

16. The system of claim 12, wherein the at least one computing device is further configured to determine a duration of the time period over which the adjusted bid setting is applied by:
receiving historical traffic data indicative of user activity relating to the subject matter of the first content item during one or more past instances in which content items relating to the subject matter of the first content item were presented through the first communication medium;
for each of the one or more past instances, determining a time period during which a magnitude of the traffic data exceeded a threshold; and
determining the duration of the time period over which the adjusted bid setting is applied based on the time periods during which the magnitude of the traffic data exceeded the threshold for the one or more past instances.

17. The system of claim 12, wherein the at least one computing device is further configured to determine a duration of the time period over which the adjusted bid setting is applied by:
monitoring real-time traffic data indicative of user activity relating to the subject matter of the first content item; and
determining the duration of the time period over which the adjusted bid setting is applied based on a characteristic of the real-time traffic data.

18. The system of claim 12, wherein the at least one computing device is further configured to:
monitor traffic data indicative of user activity relating to the subject matter of the first content item; and
determine an adjustment amount applied to the current bid setting to generate the adjusted bid setting based on at least one of a magnitude or a rate of change of the traffic data.

19. The system of claim 12, wherein the at least one computing device is configured to determine the time at which the first content item is likely to have been presented through the first communication medium by:
receiving a content stream being transmitted through the first communication medium;
comparing the content stream to one or more stored content samples associated with the content provider, wherein the one or more stored content samples include the first content item;
determining whether a portion of the content stream matches the first content item; and
in response to determining that the portion of the content stream matches the first content item, activating a trigger signal indicating that the first content item has been presented through the first communication medium;
wherein the current bid setting is adjusted in response to the trigger signal.

20. One or more computer-readable storage media having instructions stored thereon that, when executed by at least one processor, cause the at least one processor to perform operations comprising:
determining a time at which a first content item of a content provider is likely to have been presented to a plurality of users through a broadcast communication medium based on at least one of a schedule received from the content provider or analysis of traffic data indicative of user activity relating to a subject matter of the first content item, wherein the at least one processor is configured to receive one or more bids from the content provider for one or more content auctions for content items to be displayed within a content interface presented on one or more user devices, wherein the content interface is a different medium than the broadcast communication medium;
adjusting a current bid setting for at least one bid of the one or more bids for a time period after the determined time to generate an adjusted bid setting, wherein the at least one bid is associated with at least one second content item that is related to the subject matter of the first content item;
applying the adjusted bid setting to the at least one bid for content auctions of the one or more content auctions that are conducted during the time period, wherein the adjusted bid setting is configured to increase a likelihood that the at least one second content item will be selected for display within the content interface during the time period; and
returning the adjusted bid setting to the current bid setting after the time period has expired.
